(19) United States
(12) Patent Application Publication
(10) Pub. No.: US 2013/0047801 A1
(43) Pub. Date: Feb. 28, 2013

(54) Gear Backlash Tool and Method of Using Same

(71) Applicants: Adam William Ostein, Edelstein, IL (US); Benjamin Carl Thomas, Peoria, IL (US); Christopher Lee Bach, Chillicothe, IL (US); Curtis John Graham, Peoria, IL (US)

(72) Inventors: Adam William Ostein, Edelstein, IL (US); Benjamin Carl Thomas, Peoria, IL (US); Christopher Lee Bach, Chillicothe, IL (US); Curtis John Graham, Peoria, IL (US)

(73) Assignee: Caterpillar, Inc., Peoria, IL (US)

(21) Appl. No.: 13/216,869

(22) Filed: Aug. 24, 2011

(51) Int. Cl. B25B 11/00

(52) U.S. Cl. 81/484

(57) ABSTRACT

A tool for use in adjusting the relative position of one gear to another is provided. The tool may be used to set and adjust the backlash between a camshaft gear and an adjustable idler gear in an internal combustion engine.

### TECHNICAL FIELD

This disclosure relates generally to gear trains in internal combustion engines. More particularly, this disclosure relates to a tool for setting and adjusting the gear backlash in an overhead camshaft gear train for an internal combustion engine and a method of using same.

### BACKGROUND

In typical internal combustion engines having an overhead camshaft, the camshaft is driven by the engine crankshaft via a gear train assembly. In addition to the crankshaft gear and the camshaft gear, the gear train assembly typically includes one or more intermediate idler gears whose primary function is to transmit rotation from the crankshaft gear to the camshaft gear. The proper meshing (spatial arrangement) of the gears, particularly the meshing of the idler gear with the overhead camshaft gear, is critical to engine performance.

The spatial arrangement of the idler gear and the camshaft gear is a function of, among others things, cylinder head thickness and engine block height. Any change in cylinder head thickness or engine block height can affect the gear meshing. Gear meshing can also be affected during normal engine operation due to compression of the cylinder head gasket and maintenance disturbances during engine repair.

Improper gear meshing can result in excessive backlash, defined as the gap between the trailing faces of the driving gear teeth to the leading faces of the driven gear teeth. Backlash can cause excessive noise, gear wear and even gear failure.

Current gear backlash tools are generally limited to setting the initial correct position of the adjustable idler gear with respect to the camshaft gear at a nominal cylinder head thickness and engine block height. Setting the initial correct position of the idler gear and camshaft gear is a simple matter of installing a gear backlash tool onto the ends of the camshaft and idler gear stub shaft (with the idler gear removed) and then tightening the bolts that hold the idler gear in place.

Conventional gear backlash tools are useless for setting backlash when the cylinder head thickness or engine height vary from their nominal dimensions, which frequently occurs after an engine repair or even after normal engine wear and tear. In such cases the engine must be returned to the shop for switching out an engine component, usually the cylinder head, to return the engine to its original tolerances (cylinder head thickness or engine height), and then using a conventional gear backlash tool to set backlash.

It would therefore be beneficial to provide an improved tool for adjusting gear backlash that can be used to adjust and set gear backlash for any engine configuration, including when the cylinder head thickness or engine height vary from their nominal dimensions.

It is yet another object of the invention to provide a gear backlash tool that can be used in the field to adjust gear backlash whenever an engine repair disturbs the gear train or when normal engine operation warrants an adjustment.

### SUMMARY OF THE DISCLOSURE

In accordance with one aspect of the present disclosure, there is provided a device for adjusting backlash between a first gear such as an overhead camshaft gear and an adjustable gear such as an adjustable idler gear in, for example, an internal combustion engine. The adjustable idler gear has a central bore and is removably mountable on a backplate and configured to mesh directly with the camshaft gear and a second gear. The backplate is adjustably mounted to a structure such as a gear case or engine block and comprises a substantially planar body and a stub shaft extending outward from the backplate body and normal to the plane of the backplate body. The stub shaft is configured to receive the adjustable idler gear. The backplate body defines openings for receiving a first set of retaining members or studs extending from the gear case, the first set of studs being configured to receive a first set of fasteners to secure the backplate to the gear case.

The backlash adjustment tool comprises a central body and two arms. The body preferably is substantially cylindrical and has a central bore sized to accommodate the backplate stub shaft. The arms extend outward from the central body and comprise gear teeth configured to engage the camshaft gear and the second idler gear.

In an important aspect of the invention, the tool can be installed onto the backplate stub shaft with the gear teeth engaging the camshaft gear and the second idler gear without obscuring the first set of studs. This may be achieved by forming each arm in the shape of an arcuate member or annular segment extending outward from the central body with gear teeth extending radially outward from the annular segment and circumferentially disposed about a central axis, where the gear teeth of one arm are configured to mesh with the camshaft gear and the gear teeth of the other arm are configured to mesh with the second gear when the tool is installed onto the stub shaft. In one workable embodiment each annular segment defines an arc having a length less than about sixty (60) degrees.

In another aspect of the invention, a method of adjusting the backlash between an overhead camshaft gear and an adjustable idler gear is provided. The method may comprise the following steps:

removing the adjustable idler gear from the backplate stub shaft, thereby exposing a first set of studs;

removing the first set of fasteners from the first set of studs;

providing a backlash adjustment tool having a substantially cylindrical central body and a pair of arms, each arm comprising a set of gear teeth, one set of gear teeth configured to mesh with the camshaft gear and the other set of gear teeth configured to mesh with the second gear;

installing the tool onto the backplate stub shaft so that the gear teeth of one arm mesh with the camshaft gear and the gear teeth of the other arm mesh with the second gear;

adjusting (moving) the backplate to a desired position; tightening the first set of fasteners on the first set of studs to secure the backplate in stationary relationship with the gear case;

removing the tool from the backplate stub shaft; and

installing the adjustable idler gear onto the backplate.

### BRIEF DESCRIPTION OF THE DRAWINGS

FIG. 1 is a front elevational view of a gear train for an internal combustion engine having a nominal cylinder head thickness and nominal engine block height.

FIG. 2 is a front elevational view of a gear train for an internal combustion engine having a cylinder head thickness and/or engine block height different than the nominal thickness and height.

FIG. 3 is a perspective view of a prior art gear backlash tool.

FIG. 4 is a front elevational view of the prior art tool as it might be used to set gear backlash for an internal combustion engine having a nominal cylinder head thickness and nominal engine block height.

FIG. 5 is a perspective view of a gear backlash tool according to the present invention.

FIG. 6 is a front elevational view of a gear train for an internal combustion engine in which an adjustable idler gear has been removed and the tool of FIG. 5 installed in its place.

FIG. 7 is a front elevational view of the gear train of FIG. 6 after the adjusting fasteners have been installed.

FIG. 8 is a front elevational view of the gear train of FIG. 7 after the gear backlash tool has been removed.

FIG. 9 is a front elevational view of the gear train of FIG. 8 after the other fasteners have been installed.

FIG. 10 is a front elevational view of the gear train of FIG. 9 after the adjustable idler gear has been re-installed.

### DETAILED DESCRIPTION

While this invention may be embodied in many forms, there is shown in the figures and will herein be described in detail one or more embodiments, with the understanding that this disclosure is to be considered an exemplification of the principles of the invention and is not intended to limit the invention to the illustrated embodiments.

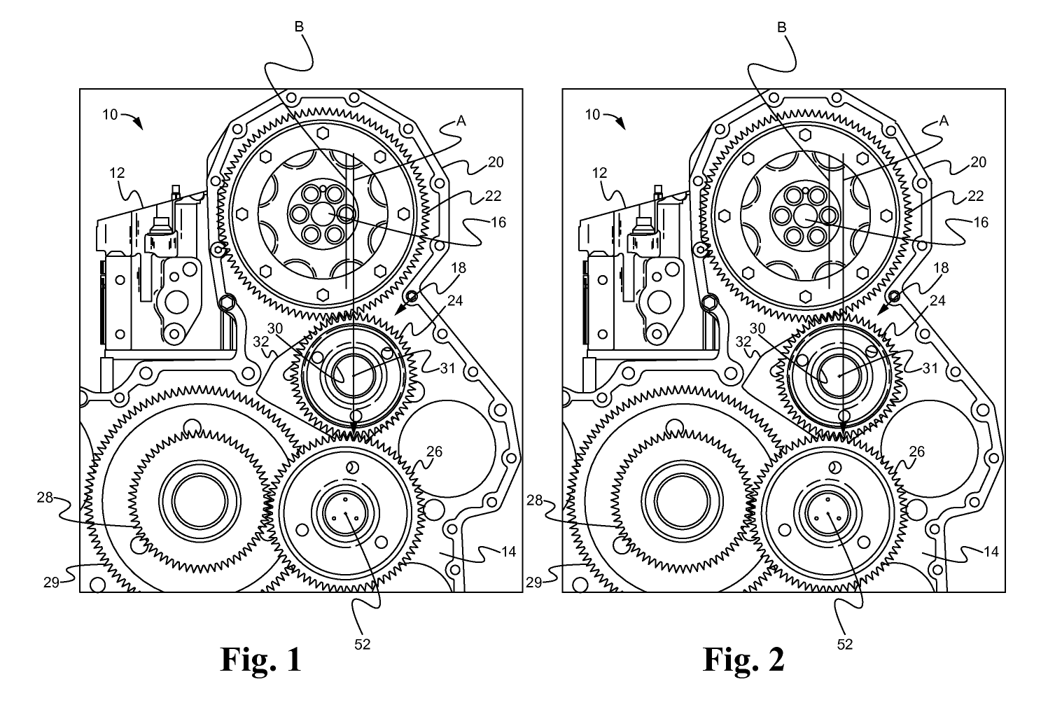

The present invention is a backlash adjustment device for adjusting the relative spatial arrangement between two gears, for example, the overhead camshaft gear and an adjustable idler gear of an internal combustion engine. FIG. 1 shows a typical internal combustion engine 10 of the type for which the present invention may be used. The engine 10 comprises a cylinder head 12 mounted on an engine block 14 with a cylinder head gasket there between.

An overhead camshaft 16 is rotatably mounted within the cylinder head 12 and is operably connected to the overhead cam valves (not shown). An overhead camshaft gear 22 is mounted to the camshaft 16 and is operably connected to a crankshaft gear via a gear train 18. The gear train 18 is mounted within a gear case 20 which in turn is mounted to the engine block 14. The gear train 18 serves to transfer rotational motion from the crankshaft (not shown) to the camshaft 16 via one or more intermediate gears. In the illustrated embodiment the gear train 18 comprises an overhead camshaft gear 22 affixed to an end of the camshaft 16, an adjustable idler gear 24, a second (stationary) idler gear 26 and cluster idler gears 28, 29. It should be understood that the gear train 18 may have as few as three gears, consisting of a stationary driven gear (i.e., the overhead camshaft gear 22), a stationary driving gear (i.e., the crankshaft gear) and an intermediate adjustable idler gear for transferring the rotational motion of the crankshaft gear to the overhead camshaft gear 22.

Still referring to FIG. 1, the adjustable idler gear 24 is in direct meshing relationship with the overhead camshaft gear 22 and the second idler gear 26. The adjustable idler gear 24 has a central bore 30 defining a central (horizontal) axis 31 and may be mountable to the gear case 20 or engine block 14 via conventional means. Specifically, the idler gear 24 may be mountable to a retaining plate or backplate 32 which in turn is adjustably mounted to the gear case 20 or engine block 14.

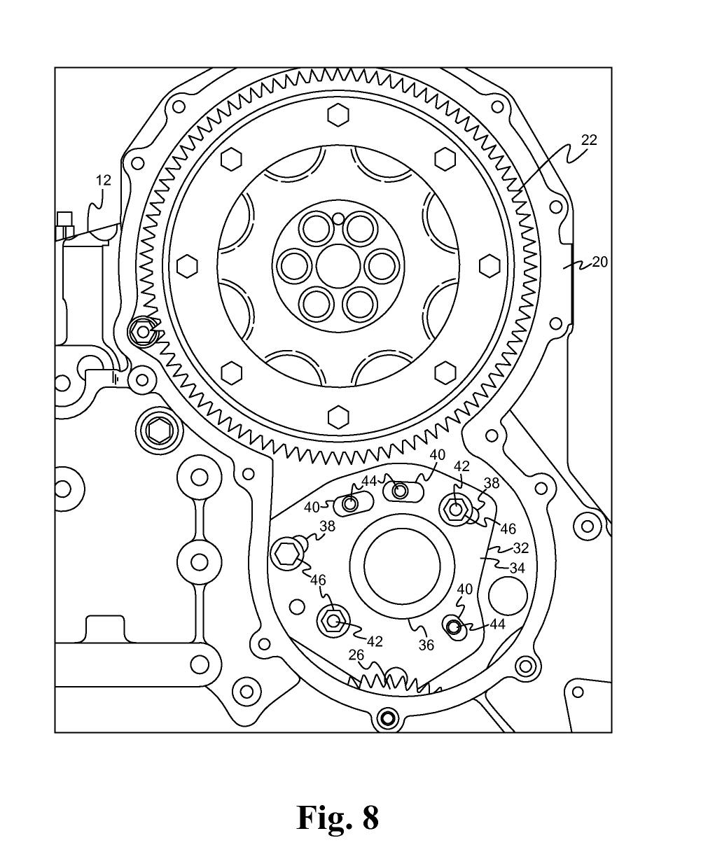

As perhaps best shown in FIG. 8, the backplate 32 comprises a substantially planar body 34 and a stub shaft 36 extending outward from the backplate body 34, normal to the plane of the body 34. The stub shaft 36 is configured to receive the adjustable idler gear 24. In the illustrated embodiment the backplate body 34 defines a first set of three openings 38 for receiving a first set of threaded retaining members or studs 42 and a second set of three openings 40 for receiving a second set of threaded studs 44. As explained below, the first set of studs 42 is configured to receive a first set of fasteners 46 to set the gear backlash, while the second set of studs 42 is configured to receive a second set of fasteners 48 to secure the backplate 32 to the engine block 14. The fasteners 46, 48 may be bolts, nuts or any other suitable fastener.

Referring again to FIG. 1, there is shown a front elevational view of a gear train 18 for an internal combustion engine 10 having a nominal cylinder head thickness and a nominal engine block height as would be the case with an OEM engine. Vertical lines “A” and “B’ are for illustrative purpose only. Vertical line “A” intersects one of the teeth on the adjustable idler gear 24 and vertical line “B” intersects a central axis 52 of the second idler gear 26. The adjustable idler gear 24 is shown in a first fixed position with respect to the second idler gear 26.

FIG. 2 is a front elevational view of a gear train 18 for an internal combustion engine showing a new alignment (location) of the adjustable idler gear 24 necessitated by, for example, a change in cylinder head thickness and/or engine block height from that shown in FIG. 1. This new alignment of the adjustable idler gear 24 maintains the desired gear backlash tolerance between the adjustable idler gear 24 and the overhead camshaft gear 22. As explained below, the new alignment is achieved by removing the adjustable idler gear 24 from the stub shaft 36 and adjusting the position of the stub shaft 36 using the tool of the present invention. In this exemplary illustration, when the adjustable idler gear 24 is remounted on the stub shaft 36, the change in stub shaft position has forced the adjustable idler gear 24 to rotate counterclockwise by one tooth, as indicated by the new position of vertical line “A” relative to vertical line “B”.

### THE PRIOR ART

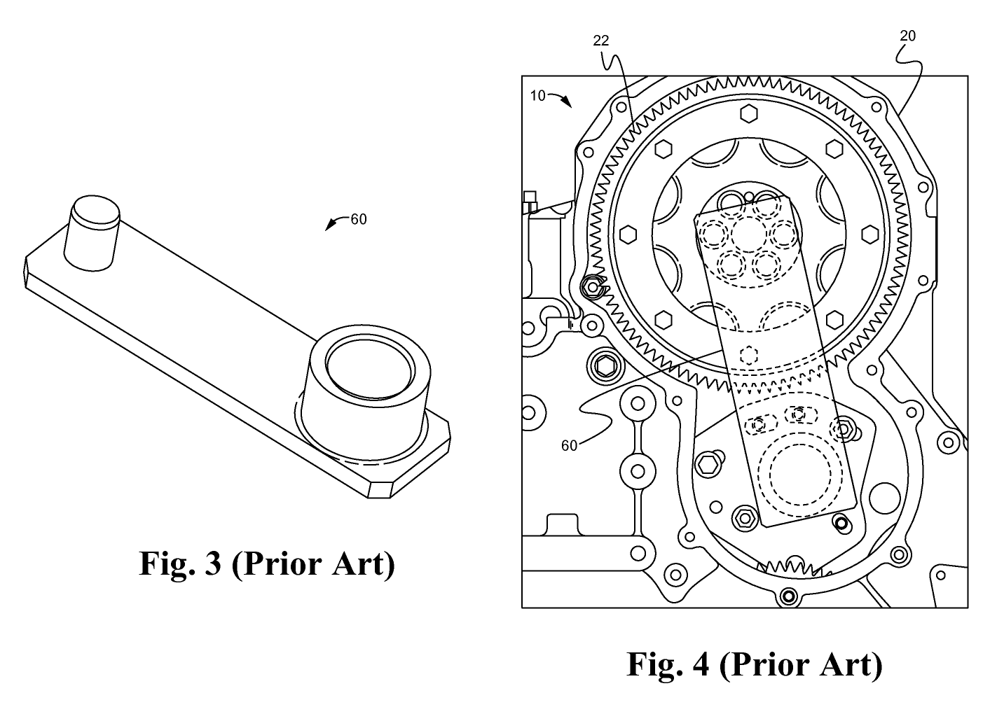

FIG. 3 is a perspective view of a prior art gear backlash tool 60. As shown in FIG. 4, the prior art tool 60 can be used to set gear backlash for an internal combustion engine having a nominal cylinder head thickness and nominal engine block height, but cannot set the gear backlash when the cylinder head thickness or engine height vary from their nominal dimensions.

Applicants have developed an improved gear backlash tool for adjusting gear backlash that can be used to adjust gear backlash for any engine configuration, including when the cylinder head thickness or engine height vary from their nominal dimensions. The improved gear backlash tool can be used by a dealer or in the field to adjust gear backlash whenever an engine repair disturbs the gear train or when normal engine operation warrants an adjustment.

The Improved Backlash Adjustment Tool

A tool 70 will now be described that can be used to adjust the backlash between the adjustable idler gear 24 and the overhead camshaft gear 22 (as well as the spatial relationship between the adjustable idler gear 24 and the second idler gear 26) when using, for example, a thinner cylinder head or shorter engine block, or in response to compression of the cylinder head gasket or maintenance disturbances.

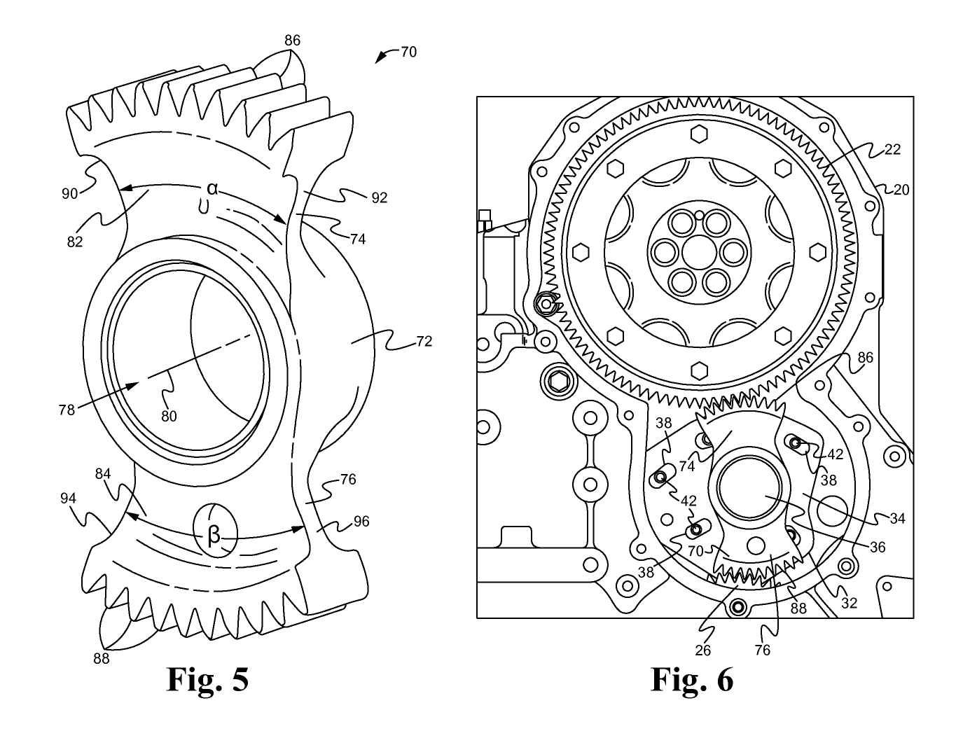

Referring now to FIG. 5, the tool 70 comprises a central body 72 and a pair of spaced apart first and second arms 74, 76 extending substantially radially outward from the body 72. The tool body 72 is substantially cylindrical, defines a central bore 78 sized to accommodate (slide over) the backplate stub shaft 36, and has a center axis of rotation 80.

The first arm 74 comprises an annular segment 82 extending radially from the central body 72 and gear teeth 86 extending radially outward from the annular segment 82 and circumferentially located about the center axis of rotation 80. Likewise, the second arm 76 comprises an annular segment 84 extending radially from the central body 72 and gear teeth 88 extending radially outward from the annular segment 84 and circumferentially located about the center axis of rotation 80. The annular segments 82, 84 are in substantially planar alignment, and the gear teeth geometry (shape and relative positioning) and gear teeth spacing of the tool 70 is substantially identical to that of the adjustable idler gear 24 so that, when the tool 70 is installed onto the stub shaft 36, the gear teeth 86 of the first arm 74 mesh with the overhead camshaft gear 22 and the gear teeth 88 of the second arm 76 mesh with the second idler gear 26.

The first arm 74 defines an arc a measured from one side 90 of the annular segment 82 to the opposite side 92. The second arm 74 defines an arc 13 measured from one side 94 of the annular segment 84 to the opposite side 96. The length of each arc α, β is limited to a maximum length which allows the tool 70 to be installed onto the backplate 32 without obscuring (covering) the first set of studs 42, and also allows room for adjusting the backplate 32 by placing the first set of fasteners 46 onto the first set of studs 42 and tightening them with a socket wrench or other tool. In other words, when the tool 70 is installed onto the stub shaft 36, the first set of studs 42 must be sufficiently accessible so a user can remove the first set of fasteners 46 with a conventional socket wrench, adjust the position of the backplate 32 to a second position, replace the first set of fasteners 46, and tighten them with a conventional socket wrench.

For instance, in the illustrated example each tool arm 74, 76 defines an arc α, β respectively of less than about sixty (60) degrees and closer to about 58 degrees. Of course, the arcs α, β can be any length (and need not be the same length) as long as the studs 42 are exposed and there is sufficient space around them for adjusting the backplate 32 while the tool 70 is installed. In short, the tool 70 must allow the user working access to the first set of fasteners 46 while the tool 70 is installed.

The tool 70 may be made by cutting out annular segments (portions) of an adjustable idler gear 24 that normally obscure the first set of studs 42 when the adjustable idler gear 24 is installed on the stub shaft 36. When made in this way the tool 70 dimensions would be identical to that of the adjustable idler gear from which it is made with the exception of the cut out portions.

Method of Use

The invention is also a method of adjusting the relative spatial arrangement between a first stationary gear (such as an overhead camshaft gear 22) and a second adjustable gear (such as an adjustable idler gear 24) using a backlash adjustment tool 70 of the kind described herein. The method comprises the following steps:

With the gear train cover removed the user removes adjustable idler gear 24. Next, the user removes the fasteners 46, 48 holding the backplate 32 to the gear case 20 or engine block 14 so that the backplate 32 is no longer secured in a fixed relationship to the gear case 20 or engine block 14.

Next, as shown in FIG. 6, the tool 70 is installed onto the stub shaft 36 so that the gear teeth 86 of one arm 74 mesh with the first (overhead camshaft) gear 22 and the gear teeth 88 of the other arm 76 mesh with the second (idler) gear 26. Importantly, the first set of studs 42 are exposed and can still be accessed—with space to accommodate a socket wrench—after the tool 70 is installed.

The user may then replace and hand tighten the first set of fasteners 46 onto the first set of studs 42 just enough so that a slight resistance is felt if the backplate 32 and stub shaft 36 are rotated.

Next the user can measure the current backlash between the adjustable idler gear 24 on the camshaft gear 22 at one or more locations on the gears using a conventional dial indicator. Small differences in the individual gear teeth may require checking the backlash at multiple locations.

The backplate 32 can then be moved (adjusted) as needed to a desired second position by, for example, lightly tapping on the stub shaft 36 with a soft mallet to move the stub shaft 36 closer to or farther away from the camshaft gear 22 to increase or decrease the amount of backlash.

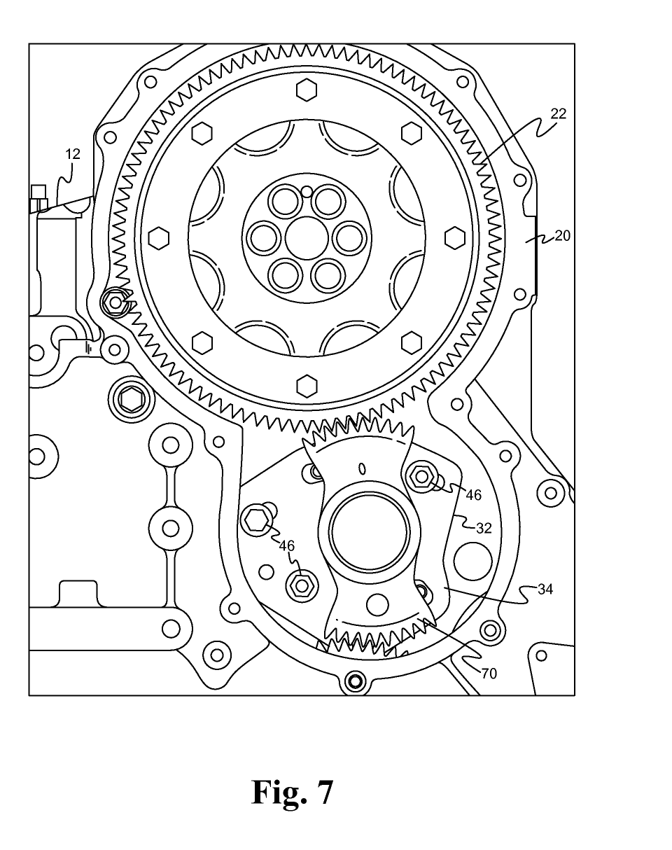

As shown in FIG. 7, with the tool 70 still installed, once the proper backlash is obtained, the user tightens the first set of fasteners 46 to secure the backplate 32 in the desired second position to the gear case 20, engine block 14 or other structure.

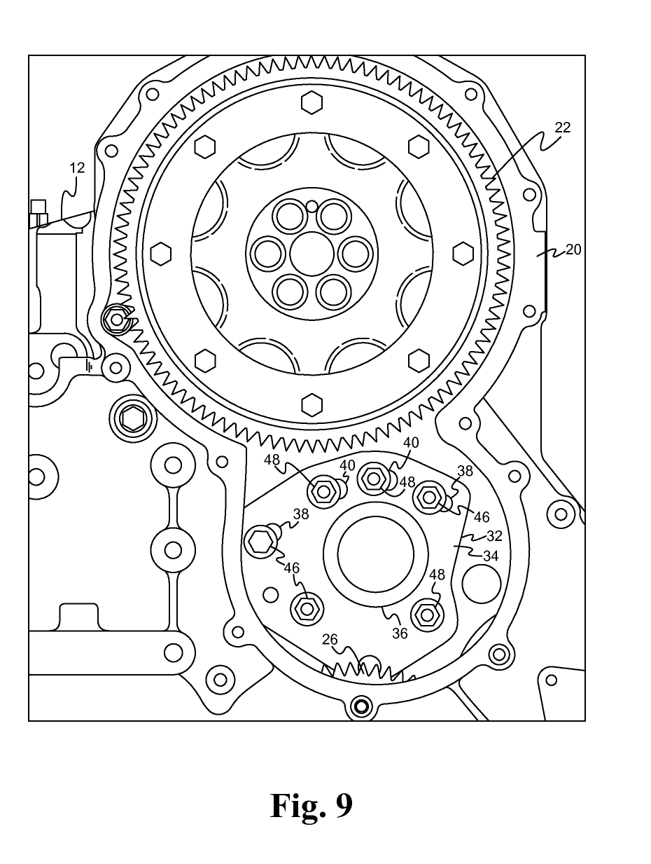

As shown in FIG. 8, with the first set of fasteners 46 tightened, the tool 70 can be removed from the stub shaft 36. With the tool 70 removed the second set of fasteners 48 can be installed onto the second set of studs 44 and tightened as shown in FIG. 9.

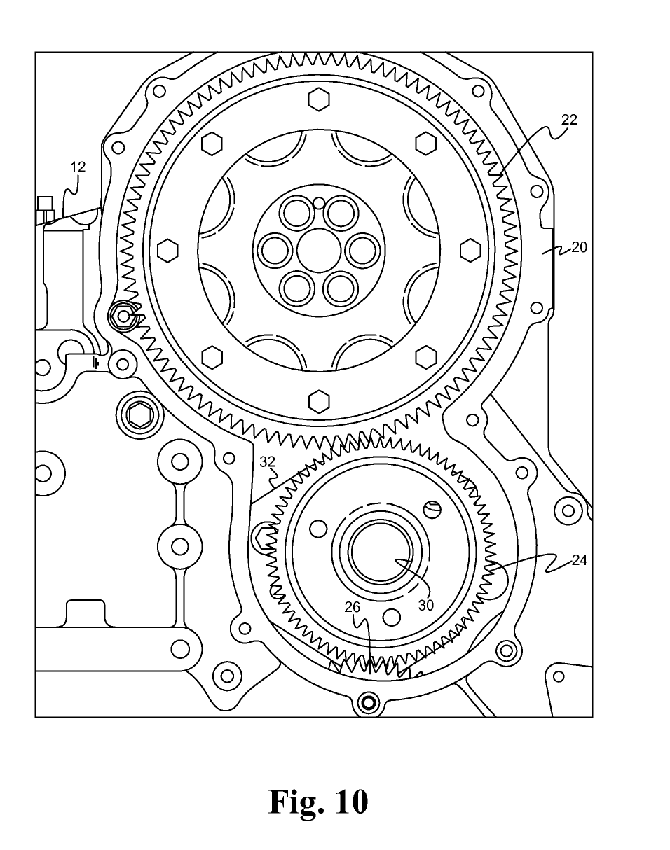

Finally, the adjustable idler gear 24 can be re-installed onto the stub shaft 36 as shown in FIG. 10. The user can verify that the proper amount of backlash is still correct before installing the bolts (not shown) that secure the adjustable idler gear 24 to the stub shaft 36, tightening the bolts to the proper torque, and replacing the gear case cover.

### INDUSTRIAL APPLICABILITY

Thus there has been described a tool for use in adjusting the relative position of one gear to another. The present invention may be used to set and adjust the backlash between, for example, the camshaft gear and an adjustable idler gear in an internal combustion engine, including but not limited to engines for heavy duty off-road vehicles. The tool can be used during and after any engine repair that disturbs the gear train, such as any repair that involves removing the cylinder head, including replacing the camshaft or removing the cylinder packs. The tool could be used by original equipment manufacturers, by dealers as part of their ordinary technician's toolbox, or by operators in the field.

The device and method of the present invention may be suitable for use in any gear train system where a need exists to adjust one gear relative to another while allowing access to retaining studs, retaining fasteners or other retaining components normally obscured behind the adjustable gear.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A device for adjusting the relative spatial arrangement between a first gear and an adjustable gear, the adjustable gear defining a central bore and being removably mountable on a backplate and having a gear teeth configured to mesh directly with the first gear and a second gear, the backplate being adjustably mounted to a structure, the backplate comprising a substantially planar body and a stub shaft extending outward from the backplate body normal to the plane of the backplate body and configured to receive the adjustable gear, the backplate body defining openings for receiving a first set of retaining members extending from the structure, the first set of retaining members configured to receive a first set of fasteners to secure the backplate to the structure, the device comprising:
a substantially cylindrical central body having a central bore sized to accommodate the backplate stub shaft and a center axis of rotation; and
first and second spaced apart arms extending outward from the central body, the first arm comprising a first set of gear teeth configured to engage the first gear and the second arm comprising a second set of gear teeth configured to engage the second gear.

2. The device of claim 1 wherein the device can be installed onto the backplate stub shaft with the first set of gear teeth engaging the first gear and the second set of gear teeth engaging the second gear without obscuring the first set of fasteners.

3. The device of claim 2 wherein the each tool arm comprises an annular segment extending from the central body and wherein the teeth extend radially outward from the annular segment and circumferentially located about the center axis of rotation.

4. The device of claim 3 wherein the adjustable idler gear teeth and the device gear teeth have substantially the same geometry and spacing.

5. The device of claim 3 wherein each annular segment defines an arc having a length less than about 60 degrees.

6. The device of claim 3 wherein the first gear is a gear for driving a component of an internal combustion engine and the adjustable gear is an adjustable idler gear.

7. The device of claim 6 wherein the component is a camshaft.

8. The device of claim 1 made by cutting out annular portions of a gear having dimensions identical to that of the adjustment idler gear.

9. A gear backlash adjustment system comprising:
An overhead camshaft gear;
a second gear;
a backplate adjustably mounted to a structure and comprising a substantially planar body and a stub shaft extending outward from the body and normal to the plane of the backplate body, the backplate body defining openings for receiving a first set of studs extending from the structure, the first set of studs configured to receive a first set of fasteners to secure the backplate to the structure;
an adjustable idler gear, the adjustable idler gear being removably mountable on the backplate stub shaft and configured to mesh directly with the camshaft gear and the second gear, and
a tool comprising a substantially cylindrical central body having a central bore sized to accommodate the backplate stub shaft, and a pair of arms, each arm comprising an annular segment extending radially from the central body and gear teeth extending radially from the annular segment, the gear teeth of each arm configured to engage the camshaft gear and the second idler gear respectively.

10. The device of claim 9 wherein the device can be installed onto the backplate stub shaft with the gear teeth engaging the camshaft gear and the second idler gear without obscuring the first set of studs.

11. The device of claim 9 wherein each annular segment defines an arc having a length less than about 60 degrees.

12. A method of adjusting the backlash between an overhead camshaft gear and an adjustable idler gear, the adjustable idler gear having a central bore and being removably mounted on a backplate and configured to mesh directly with the camshaft gear and a second gear, the backplate being adjustably mounted to a structure in a first position, the backplate comprising a substantially planar body and a stub shaft extending outward normal to the plane of the backplate body and configured to receive the adjustable idler gear, the backplate body comprising a first set of openings for receiving a first set of studs extending from the structure, the first set of studs configured to receive a first set of fasteners to secure the backplate to the structure in stationary relationship therewith, the method comprising:
removing the adjustable idler gear from the backplate stub shaft;
removing the first set of fasteners from the first set of studs;
providing a backlash adjustment tool having a substantially cylindrical central body with a central bore for installing the tool onto the stub shaft and a pair of arms, each arm comprising a set of gear teeth;
installing the tool onto the backplate stub shaft so that the gear teeth of one arm mesh with the camshaft gear and the gear teeth of the other arm mesh with the second gear;
moving the backplate to a desired second position;
tightening the first set of fasteners on the first set of studs to secure the backplate in stationary relationship with the gear plate;
removing the tool from the backplate stub shaft; and
installing the adjustable idler gear onto the backplate.
